(19) United States
(12) Patent Application Publication
(10) Pub. No.: US 2025/0310233 A1
(43) Pub. Date: Oct. 2, 2025

(54) NETWORK DEVICE THAT DEALS WITH NETWORK SPEED TEST BY COUNTING ALL RECEIVED PACKETS THROUGH HARDWARE AND PROACTIVELY DROPPING SOME PACKETS AND RELATED NETWORK SPEED TEST METHOD

(71) Applicant: Airoha Technology (Suzhou) Limited, Suzhou City (CN)

(72) Inventor: Tao Liu, Suzhou City (CN)

(73) Assignee: Airoha Technology (Suzhou) Limited, Suzhou City (CN)

(21) Appl. No.: 19/070,490

(22) Filed: Mar. 4, 2025

(30) Foreign Application Priority Data
Mar. 28, 2024 (CN) 202410370360.4

(51) Int. Cl. H04L 43/55; H04L 41/50; H04L 47/32; H04L 69/16

(52) U.S. Cl. CPC H04L 43/55; H04L 47/32; H04L 69/16; H04L 41/50

(57) ABSTRACT

A network device includes a network interface hardware circuit, a storage device, and a processor. The network interface hardware circuit receives packets from another network device. The network interface hardware circuit includes a counter and a proactive packet dropping circuit. The counter counts the packets during a period of network speed test, wherein the packets include first packets and second packets. The proactive packet dropping circuit proactively drops the second packets during the period of network speed test. The storage device stores a program code. The processor loads and executes the program code to perform the following operation: during the period of network speed test, reading packet count values of the counter that are generated at different time instants to calculate a number of received packets at the network device within a time interval between the different time instants.

### BACKGROUND OF THE INVENTION

### 1. Field of the Invention

The present invention relates to a network speed test technique, and more particularly, to a network device and a related network speed test method that can reduce the burden of a processor (particularly, a processor with limited computing power) by counting all received packets through hardware and proactively dropping/discarding some packets, while meeting requirements of a network speed test of a high-speed network.

### 2. Description of the Prior Art

Transmission Control Protocol (TCP) is a protocol belonging to the transport layer. Network devices at both ends of TCP can communicate with each other to ensure the accuracy of data transmission and control the transmission rate. For example, TCP uses two mechanisms, including acknowledgment and re-transmission, to ensure the accuracy and reliability of TCP packets transmitted over the network. Therefore, the overall transmission procedure is less efficient, but it can ensure that TCP packets are correctly transmitted from a sender to a receiver. However, such a feature may not be necessary for certain applications. For example, a network speed test application actually does not care about the correctness of transmitted data contents. As network speeds continue to increase, conventional TCP-based network speed test applications may encounter bandwidth bottlenecks and seriously underestimate the user's actual network speed.

User Datagram Protocol (UDP) is another protocol belonging to the transport layer. TCP and UDP are both transport layer protocols. The main difference between TCP and UDP is whether they provide reliable transmission. TCP has a high degree of reliability. In contrast, UDP focuses on efficiency and does not care about packet loss. Therefore, a UDP-based network speed test application can be used as an alternative of a traditional network speed test application. However, regarding a network device that uses a processor with limited computing power, using the processor to parse each UDP packet required for a download speed test consumes a lot of processor resources and memory resources. Even if the download speed test can completely occupy the processor's working time, the maximum network speed that can be measured by the download speed test is still far lower than the actual network speed due to the limited computing power of the processor, which fails to meet requirements of a network speed test of a high-speed network.

### SUMMARY OF THE INVENTION

One of the objectives of the claimed invention is to provide a network device and a related network speed test method that can reduce the burden of a processor (particularly, a processor with limited computing power) by counting all received packets through hardware and proactively dropping some packets, while meeting requirements of a network speed test of a high-speed network.

According to a first aspect of the present invention, an exemplary network device is disclosed. The exemplary network device includes a network interface hardware circuit, a storage device, and a processor. The network interface hardware circuit is arranged to receive a plurality of packets sent from another network device. The network interface hardware circuit includes a counter and a proactive packet dropping circuit. The counter is arranged to count the plurality of packets during a period of a network speed test, wherein the plurality of packets include a plurality of first packets and a plurality of second packets. The proactive packet dropping circuit is arranged to proactively drop the plurality of second packets among the plurality of packets during the period of the network speed test. The storage device is arranged to store a program code. The processor is arranged to load and execute the program code to perform following operation: during the period of the network speed test, reading packet count values of the counter that are generated at different time instants to calculate a number of received packets at the network device within a time interval between the different time instants.

According to a second aspect of the present invention, an exemplary network speed test method is disclosed. The exemplary network speed test method includes: receiving, by a network interface hardware circuit, a plurality of packets from a network, including: during a period of a network speed test, using a counter to count the plurality of packets that include a plurality of first packets and a plurality of second packets, proactively dropping the plurality of second packets among the plurality of packets; and executing a program code to perform following operation: during the period of the network speed test, reading packet count values of the counter that are generated at different time instants to calculate a number of received packets within a time interval between the different time instants.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a diagram illustrating a packet format complying with a TR-471 speed test protocol.

FIG. 3 is a diagram illustrating packet exchange between a sender and a receiver according to the TR-471 speed test protocol.

FIG. 4 is a diagram illustrating an operation of calculating a drop count according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . .”. Also, the term “couple” is intended to mean either an indirect or direct electrical connection. Accordingly, if one device is coupled to another device, that connection may be through a direct electrical connection, or through an indirect electrical connection via other devices and connections.

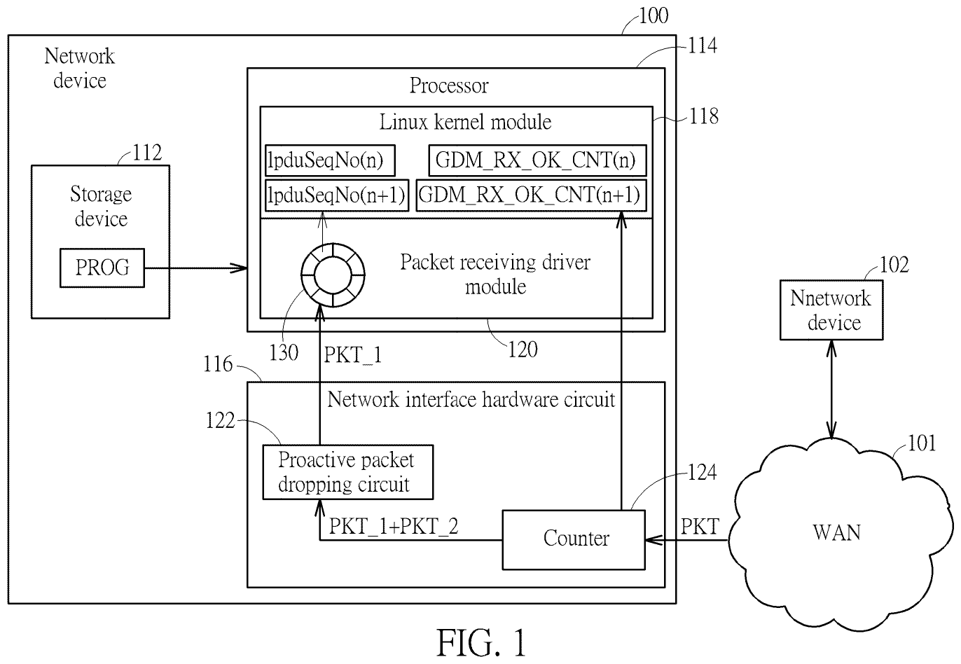

FIG. 1 is a diagram illustrating a network device according to an embodiment of the present invention. The network device 100 can perform data exchange with another network device 102 through a wide area network (WAN) 101. For example, the network device 100 may act as a client, and the network device 102 may act as a server. Hence, the network device 100 may request the network device 102 to send packets to the network device 100 for a downlink speed test. In this embodiment, the network device 100 may be an Optical Network Unit (ONU), but the present invention is not limited thereto. Any network device using the network speed test scheme proposed by the present invention falls within the scope of the present invention. The network device 100 includes a storage device 112, a processor 114, and a network interface hardware circuit 116. It should be noted that only the components pertinent to the present invention are illustrated in FIG. 1. In practice, the network device 100 may include additional components to achieve other functions. The storage device 112 may be a memory or any component with data storage capability, and is used to store a program code PROG. For example, the program code PROG may include the program code of an operating system (OS). In this embodiment, the program code PROG may have a plurality of software modules, including (but not limited to) a Linux kernel module 118 and a packet receiving driver module 120. The processor 114 is arranged to load and execute the program code PROG to control operations of the network device (e.g., client) 100. For example, the processor 114 may be a general purpose processor, and the Linux kernel module 118 supports the TR-471 speed test protocol (which is a UDP-based speed test protocol). Therefore, the processor 114 can deal with operations related to software control in the network speed test scheme of the present invention through executing the program code PROG (which includes the Linux kernel module 118 and the packet receiving driver module 120).

The network interface hardware circuit 116 is arranged to deal with operations related to hardware control in the network speed test scheme of the present invention. For example, the network interface hardware circuit 116 may be a network interface card (NIC) that is used to receive a plurality of packets PKT sent from another network device (e.g., server) 102 via WAN 101 for downlink speed test. In this embodiment, the network interface hardware circuit 116 is a functional block implemented using pure hardware, and can additionally support the hardware functions required by the network speed test scheme of the present invention. For example, the network interface hardware circuit 116 includes a proactive packet dropping circuit 122 and a counter 124. The counter 124 is arranged to count a plurality of packets PKT successfully received by the network interface hardware circuit 116 during a period of a network speed test (e.g., downlink speed test). For example, each time the network interface hardware circuit 116 successfully receives one packet PKT from WAN 101, an increment is added to a packet count value GDM_RX_OK_CNT maintained by the counter 124 (e.g., GDM_RX_OK_CNT=GDM_RX_OK_CNT+1).

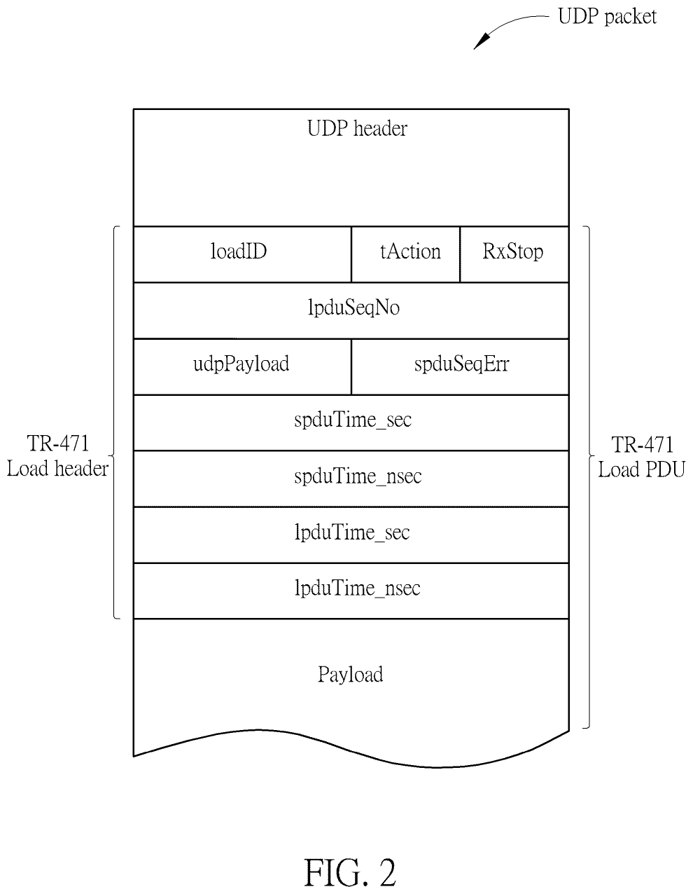

In this embodiment, the proactive packet dropping circuit 122 can proactively drop some packets among the plurality of packets PKT successfully received by the network interface hardware circuit 116. For example, the plurality of packets PKT may include a plurality of first packets PKT_1 and a plurality of second packets PKT_2. During a period of the network speed test (e.g., downlink speed test), the proactive packet circuit 122 proactively drops the plurality of second packets PKT_2 among the plurality of packets PKT. For example, N packets PKT_2 will be dropped per M packets PKT, where M>N and N≥1. Furthermore, in this embodiment, each packet PKT may be a UDP packet that includes a UDP header and a UDP payload. In addition, each packet PKT carries a Load Protocol Data Unit (Load PDU) in a packet format that complies with a TR-471 speed test protocol. As shown in FIG. 2, a UDP payload of a UDP packet includes a Load PDU (which includes a load header and a payload).

Regarding the plurality of first packets PKT_1 that are not proactively dropped by the proactive packet dropping circuit 122, the network interface hardware circuit 116 writes the plurality of first packets (i.e., UDP packets that are not proactively dropped) PKT_1 one by one into a packet buffer (not shown) through direct memory access (DMA). In addition, the network interface hardware circuit 116 further writes a packet descriptor of each first packet (i.e., UDP packet that is not proactively dropped) PKT_1 into a receive (RX) ring buffer 130, wherein the packet descriptor of the first packet (i. e., UDP packet that is not proactively dropped) PKT_1 records information about an actual storage address of the first packet (i.e., UDP packet that is not proactively dropped) PKT_1 in the memory. The Linux kernel module 118 can subsequently read the packet descriptor of the first packet (i.e., UDP packet that is not proactively dropped) PKT_1 from the RX ring buffer 130 through the packet receiving driver module 120, obtain the first packet (i.e., UDP packet that is not proactively dropped) PKT_1 from the memory according to the storage address information provided by the corresponding packet descriptor, and perform packet parsing on the first packet (i.e., UDP packet that is not proactively dropped) PKT_1.

In this embodiment, the processor 114 is a processor with limited computing power, such as an ARM processor operating at 1.2 Gigahertz (GHz). Since the packet parsing task of the processor 114 consumes a lot of resources, the processor 114 is unable to test the actual speed of the network by parsing enough packets during the required time period. In order to address this issue, the network device 100 of the present invention can count all received packets through the network interface hardware circuit 116 and can proactively drop some packets to reduce the burden of the processor 114 and meet the requirements of a network speed test of a high-speed network. Specifically, through the speed limiting of the RX ring buffer 130, the proactive packet dropping circuit 122 can proactively drop most of the packets during the period of the network speed test, which can reduce the processor load and memory load and improve the downlink speed test capability. Further details about the network speed test scheme proposed by the present invention are described as below.

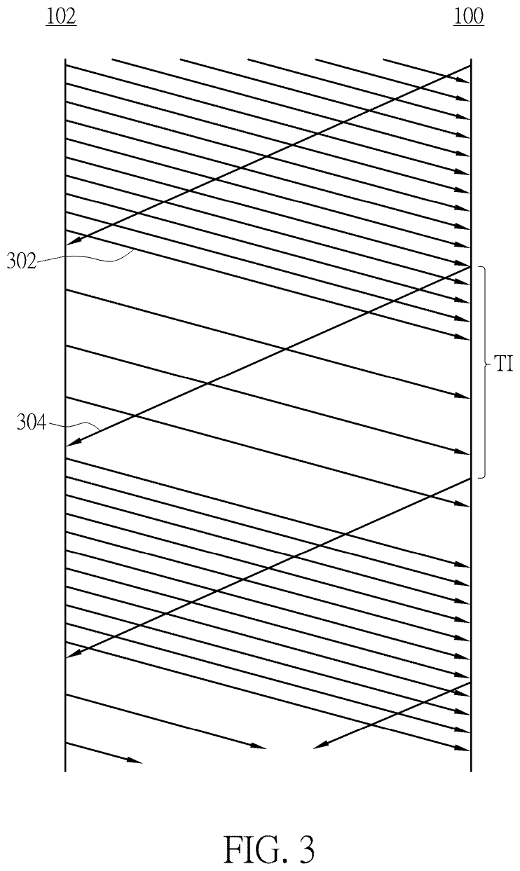

As mentioned above, the Linux kernel module 118 supports the TR-471 speed test protocol (which is a UDP-based speed test protocol). According to the TR-471 speed test protocol, when performing a downlink speed test, the network device (client) 100 acts as a receiver, and another network device (server) 102 acts as a sender. Please refer to FIG. 3. FIG. 3 is a diagram illustrating packet exchange between a sender and a receiver according to the TR-471 speed test protocol. The network device (sender) 102 sends a plurality of Load PDUs 302 in each trial interval (TI) according to a sending rate (measured in bits per second (bps)) that is set for the current TI. In addition, the network device (receiver) 100 parses each of the received Load PDUs 302 to gather statistical information such as drop count, out of order, and round trip time (RTT). At the end of each TI, the statistical information is written into a Status Feedback PDU 304 and reported to the network device (sender) 102. Next, the network device (sender) 102 dynamically adjusts the sending rate to be used by the next TI according to the statistical information carried by the Status Feedback PDU 304.

According to the sending rate adjustment method adopted by the TR-471 speed test protocol, if there is no packet loss during the current TI, the sending rate of the next TI will be increased; on the contrary, if there is packet loss during the current TI, the sending rate of the next TI will be decreased. For example, when the current sending rate is below 1 GHz and no packet loss occurs, each adjustment made to the sending rate will be an increment of 10 Mbps; when the current sending rate is below 1 GHz and packet loss occurs, each adjustment made to the sending rate will be a decrement of 30 Mbps; when the current sending rate is above 1 GHz and no packet loss occurs, each adjustment made to the sending rate will be an increment of 100 Mbps; when the current sending rate is above 1 GHz and packet loss occurs, each adjustment made to the sending rate will be a decrement of 100 Mbps. According to the traditional approach, the number of packets (i.e., the number of Load PDUs complying with the TR-471 speed test protocol) received by the receiver needs to be counted by the receiver's processor. In other words, the receiver's processor needs to parse each received packet (i.e., the Load PDU carried by the UDP packet) to calculate the drop count. However, such a packet parsing task consumes a lot of processor resources and memory resources.

In this embodiment, the program code (e.g., Linux kernel module 118) executed by the processor 114 only needs to parse the plurality of first packets (i.e., UDP packets that are not proactively dropped) PKT_1, and does not need to parse all packets PKT, including PKT_1 and PKT_2, successfully received by the network interface hardware circuit 116. In this way, the processor 114 does not consume a lot of processor resources and memory resources when parsing the plurality of first packets (i.e., UDP packets that are not proactively dropped) PKT_1. According to the TR-471 speed test protocol, the “lpduSeqNo” field in the load header shown in FIG. 2 is used to record a sequence number of the Load PDU. The program code (e.g., Linux kernel module 118) executed by the processor 114 can obtain a corresponding sequence number by parsing the “lpduSeqNo” field in each first packet (i.e., UDP packet that is not proactively dropped) PKT_1. In this way, the number of transmitted packets from the network device (sender) 102 to the network device (receiver) 100 during the period of the downlink speed test can be obtained through sequence numbers of Load PDUs that are obtained by the packet parsing task running on the processor 114.

As mentioned above, at the end of each TI, the network device (receiver) 100 needs to report the Status Feedback PDU to the network device (sender) 102 so that the network device (sender) 102 can dynamically adjust the sending rate to be used by the next TI according to the statistical information (particularly, the drop count) carried by the Status Feedback PDU. To obtain information of the drop count, in addition to performing the packet parsing task through the processor 114 to know the number of transmitted packets from the network device (sender) 102, the network device (receiver) 100 needs to know the number of received packets at the network device (receiver) 100. In this embodiment, the counter 124 of the network interface hardware circuit 116 counts all packets PKT successfully received by the network interface hardware circuit 116. Therefore, the program code (e.g., Linux kernel module 118) executed by the processor 114 can further read packet count values of the counter 124 that are generated at different time instants to calculate the number of received packets at the network device (receiver) 100. Finally, the drop count can be calculated according to the number of transmitted packets from the network device (sender) 102 (which is derived from sequence numbers obtained through executing packet parsing by the software module) and the number of received packets at the network device (receiver) 100 (which is derived from count values provided by the hardware).

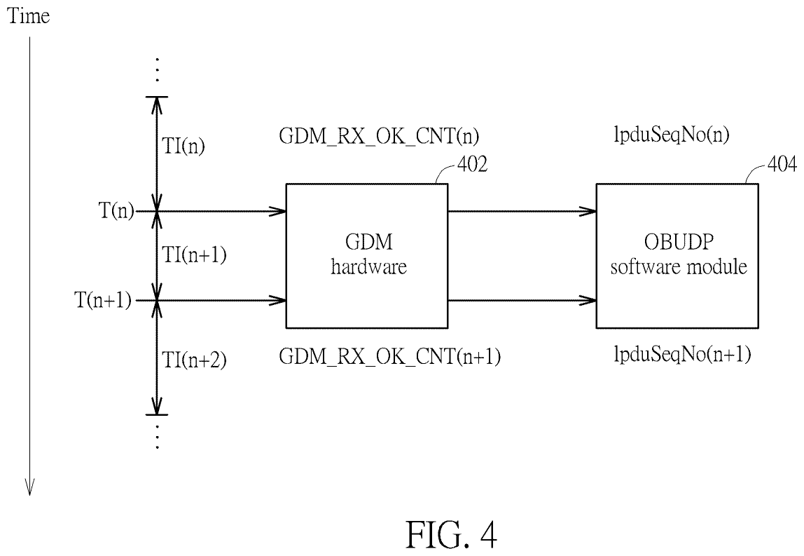

Please refer to FIG. 4. FIG. 4 is a diagram illustrating an operation of calculating the drop count according to an embodiment of the present invention. The operations related to hardware control in the network speed test scheme of the present invention can be implemented by the GDM hardware 402, and the operations related to software control in the network speed test scheme of the present invention can be implemented by the OBUDP software module 404. Based on the architecture shown in FIG. 1, the counter 124 can be implemented by the GDN hardware 402 to record the number of packets received by the network device (receiver) 100, and the Linux kernel module 118 can include the program code of the OBUDP software module 404 that is used to calculate the number of packets sent from the network device (sender) 102. The OBUDP software module 404 parses the load header of the Load PDU carried in the last UDP packet sent in each TI, to obtain a corresponding sequence number. As shown in FIG. 4, the OBUDP software module 404 parses the sequence number of the Load PDU carried in the last UDP packet sent in the previous trial interval TI(n) (i.e., the sequence number lpduSeqNo(n) corresponding to the time instant T(n)), and parses the sequence number of the Load PDU carried in the last UDP packet sent in the current trial interval TI(n+1) (i.e., the sequence number IpduSeqNo(n+1) corresponding to the time instant T(n+1)). Next, the OBUDP software module 404 can calculate the number of transmitted packets SendTxCnt(n+1) (e.g., SendTxCnt(n+1)=lpduSeqNo(n+1)−lpduSeqNo(n)) from the network device (sender) 102 in the current trial interval TI(n+1) according to the sequence numbers lpduSeqNo(n) and lpduSeqNo(n+1) obtained at the end of two consecutive trial intervals TI(n) and TI(n+1), respectively.

In addition, the OBUDP software module 404 further obtains the packet count value GDM_RX_OK_CNT(n) corresponding to the time instant T(n) and the packet count value GDM_RX_OK_CNT(n+1) corresponding to the time instant T(n+1) from the GDM hardware 402 (i.e., the counter hardware). Next, the OBUDP software module 404 can calculate the number of received packets rxCnt(n+1) (e.g., rxCnt(n+1)=GDM_RX_OK_CNT(n+1)−GDM_RX_OK_CNT(n)) at the network device (receiver) 100 in the current trial interval TI(n+1) according to the packet count values GDM_RX_OK_CNT(n) and GDM_RX_OK_CNT(n+1) obtained by the GDM hardware 402 (i.e., the counter hardware) at the end of two consecutive trial intervals TI(n) and TI(n+1), respectively.

After calculating the number of transmitted packets SendTxCnt(n+1) and the number of received packets rxCnt(n+1) in the current trial interval TI(n+1), the OBUDP software module 404 can calculate the drop count DropCnt(n+1) of the current trial interval TI(n+1) (e.g., DropCnt(n+1)=SendTxCnt(n+1)−rxCnt(n+1)), and write the drop count DropCnt(n+1) of the current trial interval TI(n+1) into one Status Feedback PDU (e.g., Status Feedback PDU 304 shown in FIG. 3) and report it to the network device (sender) 102. Next, the network device (sender) 102 dynamically adjusts the sending rate to be used by the next trial interval TI(n+2) according to the information (e.g., the drop count DropCnt(n+1) of the current trial interval TI(n+1)) carried by the Status Feedback PDU.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device comprising:
a network interface hardware circuit, arranged to receive a plurality of packets sent from another network device, wherein the network interface hardware circuit comprises:
a counter, arranged to count the plurality of packets during a period of a network speed test, wherein the plurality of packets comprise a plurality of first packets and a plurality of second packets; and
a proactive packet dropping circuit, arranged to proactively drop the plurality of second packets among the plurality of packets during the period of the network speed test;
a storage device, arranged to store a program code; and
a processor, arranged to load and execute the program code to perform following operation:
during the period of the network speed test, reading packet count values of the counter that are generated at different time instants to calculate a number of received packets at the network device within a time interval between the different time instants.

2. The network device of claim 1, wherein each of the plurality of packets is a user datagram protocol (UDP) packet.

3. The network device of claim 2, wherein the network speed test employs a TR-471 speed test protocol.

4. The network device of claim 1, wherein the network device is an optical network unit (ONU).

5. The network device of claim 1, wherein the processor is further arranged to execute the program code to perform following operation:
during the period of the network speed test, using the plurality of the first packets to calculate a number of transmitted packets from the another network device within the time interval between the different time instants, and calculating a drop count according to the number of transmitted packets and the number of received packets.

6. A network speed test method comprising:
receiving, by a network interface hardware circuit, a plurality of packets from a network, comprising:
during a period of a network speed test, using a counter to count the plurality of packets, wherein the plurality of packets comprise a plurality of first packets and a plurality of second packets; and
during the period of the network speed test, proactively dropping the plurality of second packets among the plurality of packets; and
executing a program code to perform following operation:
during the period of the network speed test, reading packet count values of the counter that are generated at different time instants to calculate a number of received packets within a time interval between the different time instants.

7. The network speed test method of claim 6, wherein each of the plurality of packets is a user datagram protocol (UDP) packet.

8. The network speed test method of claim 7, wherein the network speed test employs a TR-471 speed test protocol.

9. The network speed test method of claim 6, wherein the network speed test method is performed by an optical network unit (ONU).

10. The network speed test method of claim 6, further comprising:
execute the program code to perform following operation:
during the period of the network speed test, using the plurality of the first packets to calculate a number of transmitted packets within the time interval between the different time instants, and calculating a drop count according to the number of transmitted packets and the number of received packets.
